(19) United States
(12) Patent Application Publication
(10) Pub. No.: US 2006/0057310 A1
(43) Pub. Date: Mar. 16, 2006

(54) Ink-jet recording medium and process for producing the same

(76) Inventors: Atsushi Suzuki, Tokyo (JP); Norifumi Tanaka, Tokyo (JP); Yoshio Yoshida, Tokyo (JP); Masanori Kawashima, Tokyo (JP); Yoshiharu Hashiguchi, Hyogo (JP); Yoko Matsunaga, Hyogo (JP)

Correspondence Address: Gary C. Cohn;Gary C. Cohn, Suite 105, 4010 Lake Washington Boulevard NE, Kirkland, WA, 98033, US

(21) Appl. No.: 10/532,531

(22) PCT Filed: Nov. 12, 2003
(86) PCT No.: PCT/JP03/14354

§ 371 Date: Apr. 25, 2005

(30) Foreign Application Priority Data
Nov. 12, 2002 (JP) 2002-328289

(51) Int. Cl. B41M 5/00

(52) U.S. Cl. 428/32.1

(57) ABSTRACT

An inkjet recording medium containing an ink absorbing layer the main component of which are fine inorganic particles having an average particle diameter of from 10 nm to 500 nm on a base material and a glossy layer obtained by coating a polymer dispersion over the ink absorbing layer wherein the polymer dispersion is a dispersion of fine, non cross-linked styrene-acrylic type polymer particles obtained by a copolymerization reaction of monomer components containing at least a cationic monomer, (meth)acrylamide, styrene and methyl methacrylate, said glossy layer is formed by having the fine polymer particles in the polymer dispersion present in the ink absorbing layer maintain their particulate shapes.

### BACKGROUND OF THE INVENTION

1. Field of the Invention

The present invention relates to an inkjet recording medium. The invention is applicable particularly to an inkjet recording medium that has high gloss and excellent ink absorption as well as excellent color development and color reproducibility yielding good image quality.

2. Description of the Prior Art

Recently, inkjet recording method has become phenomenally popular since it readily provide full color prints, less noisy in printing. This method involves ejecting small droplets of ink which contains a large amount of solvent from a nozzle at high-speed and forming images and letters by allowing the droplets to adhere to a recording medium. Therefore, a recording medium should absorb the ink quickly. In addition, the recent growth in popularity of computers and digital cameras resulted in quality images approaching the quality of silver halide photographs being sought. Therefore, an inkjet paper should have excellent color development properties, high resolution and excellent color reproducibility, and a so-called coated paper containing an ink absorbing layer on the surface was developed in response to the need.

Glossing over a recording papers were conducted to obtain an inkjet recording method yielding silver halide photograph quality images with excellent color developing properties, high resolution and color reproducibility. The prior art used to obtain glossy inkjet recording papers included, for example, the disclosures of a method wherein a colloid particle layer containing particles having a particle diameter of 300 nm or less is formed on an ink absorbing layer, a gloss equivalent to 75 degree specular gloss of 25% or more is imparted and two or more ink absorbing layers which contain colloidal silica and binder formed on the base material, and a method wherein two or more layers of an ink absorbing layer are formed and the top layer is used to impart gloss. (For example, refer to Unexamined Japanese Patent Publications (KOKAI) Hei 07-101142, Hei 09-183265, Hei 03-215080, Hei 03-256785, Hei 07-89220 and Hei 07-117335.) The inventors previously proposed an inkjet recording paper comprising a base material with an ink absorbing layer and a colloidal silica layer formed consecutively on said base material [Unexamined Japanese Patent Publication (KOKAI) 2000-190626].

As described above, a small particle diameter pigment, such as colloidal silica particles, and a binder are generally and frequently used to impart gloss, but the disadvantage of using this approach is the fact that the use of spherical colloidal particles results in less voids when a film is formed, reducing the ink absorption rate. In addition, colloidal silica differs from synthetic amorphous silica in that it has no internal voids, and, when colloidal silica is used in an ink absorbing layer, the ink absorbing layer needs to be thick in order to obtain the ink absorption capacity needed. However, flaking tends to occur when an ink absorbing layer is thick. Therefore, when the binder content is increased to prevent flaking, the particular disadvantage is that the surface ink absorption rate decreases, causing bleeding, and a high resolution printed image is not obtained.

Furthermore, high gloss may also be imparted by simply passing a paper through rollers, for example, using super calendering and gloss calendering methods with added pressure and heat. However, colloidal silica, as well as other inorganic pigments commonly used in ink absorbing layers, lacks thermoplasticity and is not deformed, resulting not only in the disadvantage of not obtaining desired high gloss but also the disadvantage of decreasing ink absorption properties due to reduced voids in the coating layer.

On the other hand, for the purpose of obtaining a recording sheet with excellent ink absorption properties, color optical density and gloss, an inkjet recording sheet containing at least one layer containing cationic organic particles having a weight average particle diameter of from 1 nm to 1,000 nm is known. However, in this case, the layer containing fine cationic organic particles is also the ink absorbing layer, and a coating weight of about 20 g/m² is needed. In addition, to impart gloss, a calendering treatment needs to be conducted at a temperature approximating the glass transition temperature of the cationic organic particles [Unexamined Japanese Patent Publication (KOKAI) 2002-086905). For this reason, the inkjet recording sheet obtained does not yet have adequate ink absorption.

Furthermore, the application of a dispersed acrylic-styrene type polymer containing (meth)acrylamide to an inkjet recording paper for the purposes of imparting gloss and achieving ink permeability is known. In this case, the ink permeability is particularly good since said polymer dispersion was copolymerized with water soluble (meth)acrylamide. Furthermore, styrene and an acrylic monomer are copolymerized as the major components, and the particles have a glass transition temperature that is sufficiently higher than room temperature. In addition, by particularly using a reactive emulsifier during the polymerization, the polymer particles can be spot bonded at a temperature below the melting temperature of the copolymer obtained to form a layer retaining voids and the voids can be utilized to facilitate ink permeation [Unexamined Japanese Patent Publication (KOKAI) 2001-277704]. However, when the polymer dispersion described above was used, the disadvantages were poor color development and poor color reproducibility of recorded images.

As described above, improving all of the reciprocal properties of an inkjet recording medium such as ink absorption and gloss and also color development and color reproducibility has previously been uncommonly difficult.

### SUMMARY OF THE INVENTION

Therefore, the primary object of the present invention is to provide an inkjet recording medium having high gloss and good ink absorption in addition to yielding good image quality with excellent color development and color reproducibility.

The secondary object of the present invention is to provide a method for manufacturing an inkjet recording medium having high gloss and good ink absorption in addition to excellent color development and color reproducibility.

The inventors conducted a diligent investigation to solve the problem described above. As a result, the inventors discovered that an inkjet recording medium having high gloss, good ink absorption, good color development and good color reproducibility can be obtained by forming an ink absorbing layer containing, as the major component, fine inorganic particles having an average particle diameter of 10 nm to 500 nm on a base material and applying a special polymer dispersion on said ink absorbing layer, and accomplished the present invention.

That is, the present invention describes an inkjet recording medium containing an ink absorbing layer the main component of which are fine inorganic particles having an average particle diameter of from 10 nm to 500 nm on a base material and a glossy layer obtained by coating a polymer dispersion over said ink absorbing layer wherein said polymer dispersion is a dispersion of fine, non cross-linked styrene-acrylic type polymer particles obtained by a copolymerization reaction of monomer components containing at least a cationic monomer, (meth)acrylamide, styrene and methyl methacrylate, said glossy layer is formed by having the fine polymer particles in said polymer dispersion present in said ink absorbing layer maintain their particulate shapes.

Preferably, the average particle diameter of the fine styrene-acrylic type polymer particles in said polymer dispersion is from 100 nm to 200 nm. And preferably, said fine inorganic particles comprise a colloidal silica obtained by the coagulation of multiple numbers of spherical colloidal silica particles having a primary particle diameter of from 10 nm to 100 nm while dispersed in a coating solution that is used to form said ink absorbing layer.

Preferably, 75 degree specular gloss is 50% or more for said glossy layer surface, and an under layer comprising synthetic silica and a hydrophilic binder is formed between said base material and said ink absorbing layer. In one preferred mode, said polymer dispersion contains, as the monomer component, from 2% by weight to 30% by weight of said cationic monomer.

And the present invention describes a method for manufacturing an inkjet recording medium comprising the steps of: forming an under layer comprising fine synthetic silica particles and a hydrophilic binder on a base material when necessary; subsequently forming an ink absorbing layer the main component of which is fine inorganic particles having an average particle diameter of from 10 nm to 500 nm on said under layer; forming a glossy layer on said ink absorbing layer by applying and drying a polymer dispersion that is a dispersion of fine, non cross-linked styrene-acrylic type polymer particles obtained by a copolymerization reaction of monomer components containing at least a cationic monomer, (meth)acrylamide, styrene and methyl methacrylate; and conducting a soft calendering treatment or a machine calendering treatment on said glossy layer surface at a temperature of from room temperature to 40° C.

The present invention describes a method for manufacturing an inkjet recording medium comprising the steps of: forming an under layer comprising fine synthetic silica particles and a hydrophilic binder on a base material when necessary; subsequently forming an ink absorbing layer the main component of which is fine inorganic particles having an average particle diameter of from 10 nm to 500 nm on said under layer; forming a glossy layer on said ink absorbing layer by applying and drying a polymer dispersion that is a dispersion of fine, non cross-linked styrene-acrylic type polymer particles obtained by a copolymerization reaction of monomer components containing at least a cationic monomer, (meth)acrylamide, styrene and methyl methacrylate; without conducting a calendering treatment on said glossy layer surface.

### BRIEF DESCRIPTION OF THE DRAWINGS

FIG. 1 is a photograph which indicates a glossy layer of the embodiment of the present invention.

### DESCRIPTION OF THE PREFERRED EMBODIMENTS

The base material for the inkjet recording medium of the present invention is not particularly restricted, and paper composed mainly of wood fibers, plastics such as polyethylene and the like or non-woven sheets composed mainly wood fibers or synthetic fibers may be cited. In the case of paper, internal sizing agents and fillers can be appropriately added, and also a sizing press may or may not be used with only few restrictions. In the present invention, the use of a paper having excellent ink absorption is particularly desirable.

Chemical pulps such as LBKP, NBKP and the like, mechanical pulps such as GP, PGW, RMP, TMP, CTMP, CMP, CGP and the like and recycled pulps such as DIP and the like may be included as the wood pulp used as the raw materials for the paper used as a base material in the present invention. In the present invention, one or more of various additives such as well known fillers, binders, sizing agents, fixing agents, retention aids, paper strengthening agent and the like may be added when necessary, and the paper used as a base material may be obtained by drying the mixture after forming a paper sheet in any of various paper machines such as Fourdrinier paper machine, cylinder paper machine and twin wire paper machine and the like.

An ink absorbing layer of the present invention contains fine inorganic particles having an average particle diameter of from 10 nm to 500 nm as a major component. When the average particle diameter is in this range, the particles are densely packed after a coating film is formed and the inkjet recording medium becomes glossier. A more preferred range for the average particle diameter is from 40 nm to 300 nm. When the average particle diameter is smaller than the visible light wavelength (300 nm or shorter), scattering tends not to occur, transparency of the ink absorbing layer improves and color development when printed improves.

As such fine particles, a silica sol obtained by mechanically grinding colloidal silica or synthetic silica, fine silica particles such as vapor phase silica and the like or alumina sol and fine alumina particles such as vapor phase alumina and the like may be used. In the present invention, the use of fine silica particles is preferred, and the use of colloidal silica is particularly preferred. Colloidal silica is a synthetic silica synthesized using a wet method, and its primary particle diameter is from several nm to about 100 nm with non-spherical secondary particles sometimes forming through coagulation. In addition, water based dispersions obtained by dispersing core/shell structured particles bonding acrylic polymer to the surface of spherical colloidal silica particles in a water based solvent are also included. Now, in these cases, the secondary particle diameter and the internal diameter of a core/shell structure are both used as the average particle diameter of the fine inorganic particles.

Colloidal silica packs densely to raise the coating layer strength. In addition, an ink absorbing layer may be constructed from multiple layers of two layers or more. In addition, two or more types of colloidal silica may be mixed and used. Now, ordinarily, an ink absorbing layer contains fine inorganic particles as the major component, and other complementary agents are present as minor components.

In addition, primary particles of colloidal silica particles are spherical, and they themselves have some film forming properties with the tendency becoming more pronounced as the particle diameter becomes smaller. When spherical colloidal silicas having large particle diameters are used, a binder is needed to assure the film forming property that reduces the ink absorption rate of the colloidal silica layer. On the other hand, spherical colloidal silicas having smaller particle diameters display good film forming properties but lower ink absorption rates since the voids between particles are reduced after a film is formed.

In the present invention, the use of colloidal silica present as secondary particles in a coating solution used to form an ink absorbing layer is preferred as the fine inorganic particles in an ink absorbing layer. When this type of colloidal silica is used, the ink fixing property improves. The reason is not clearly understood, but the formation of a suitable void area in the glossy layer is thought to be the cause. The presence of colloidal silica as secondary particles implies that multiple numbers of primary particles of spherical silica having a primary particle diameter of from 10 nm to 100 nm coagulated while dispersed in an ink absorbing layer coating solution. As such a colloidal silica, a chain colloidal silica wherein several to several tens of primary particles are connected (Snowtex UP series and OUP series products manufactured by Nissan Chemical Industries, Ltd.) or a pearl necklace type colloidal silica wherein several to several tens of primary particles are connected to form a circle similar to necklaces (Snowtex PS series products manufactured by Nissan Chemical Industries, Ltd.) or a cluster type colloidal silica wherein the particles are connected to form grape-like clusters (Snowtex HS series products manufactured by Nissan Chemical Industries, Ltd.) may be cited.

Here, “a cluster” refers to a structure in which basically at least two spherical colloidal silica particles are bonded when viewed from the short end a direction perpendicular to the longest direction of the coagulated material) of colloidal silica coagulated as secondary particles. In addition, “a chain” refers to the state in which only one colloidal silica particle is observed from the short end when multiple numbers of colloidal silica particles are connected on the long end. In addition, “a pearl necklace” refers to a state in which chain colloidal silica forms a circle. When a dispersed colloidal silica is examined, single colloidal silica particles that have not coagulated may also be present.

In the present invention, the use of coagulated colloidal silica forming secondary particles in an ink absorbing layer not only inhibits silica particles from falling through a tangles colloidal silica with a suitable degree of tangling when forming a film without using a binder but also can yield suitably sized voids when using it in photo type inkjet printers for which a particularly fast ink absorption rate is needed. The average primary particle diameter or average secondary particle diameter of colloidal silica may be measured using a dynamic light scattering photometer.

A glossy layer is formed on the surface of said ink absorbing layer. The formation of a thin and uniform glossy layer (a layer formed by applying a coating solution containing a cationic polymer dispersion) is preferred since the main role of the layer is to impart a gloss to a recording paper while not interfering with the ink absorption of the ink absorbing layer. The gloss does not improve due to reflection of the irregular pigment shape on the glossy layer when the particle diameter of the inorganic pigment used in the ink absorbing layer under the glossy layer is large. Therefore, fine inorganic particles described above having a small particle diameter (10 nm to 500 nm) are used as the pigment in the ink absorbing layer of the present invention.

A binder is not necessarily needed in an ink absorbing layer because colloidal silica itself has a film forming property when colloidal silica is used in the ink absorbing layer of the present invention, but a binder is used when needed. As the binder described above, water soluble polymers such as poly(vinyl alcohol), casein, gelatin and the like or water dispersible polymers such as SB latex, NB latex, acrylic latex, vinyl acetate latex and the like, for example, may be used. The number of parts added of a binder per 100 parts by weight of colloidal silica from 0 part by weight to 10 parts by weight is preferred, and 0 part by weight to 5 parts by weight is particularly preferred. When the number of parts of a binder added is greater than 10 parts by weight, the surface strength increases but the ink absorption and gloss may decline.

It is preferred to contain a cationic compound in an ink absorbing layer in the present invention. A so-called dye fixing agent containing a secondary amine, a tertiary amine or a quaternary ammonium salt that forms insoluble salts with the sulfonic acid groups or carboxyl groups in a water soluble direct dye or water soluble acidic dye contained in a water based dye ink can be cited as the cationic compound used in the present invention. Individual cationic compounds or a combination of two or more may be used.

In the present invention, sizing agents, surfactants, pigment dispersing agents, thickeners, fluidity improving agents, antifoaming agents, foam inhibitors, mold releasing agents, foaming agents, penetrating agents, coloring dyes, fluorescent brightening agents, ultraviolet absorption agents, antioxidant, preservatives, fungicide, waterproofing agents, water retention agents and the like may also be suitably added as auxiliary agent to an ink absorbing layer.

The coating weight of an ink absorbing layer can be decided based on the ink absorption capacity of an ink absorbing layer and the practical bonding strength of an ink absorbing layer to a base material. A dry coating weight one of an individual ink absorbing layer of from 1 g/m² to 12 g/m² is preferred, and from 2 g/m² to 10 g/m² is more preferred. When the dry coating weight per layer is under 1 g/m², the coated surface uniformity may becomes inadequate. Simultaneously, when the dry coating weight of an individual layer exceeds 12 g/m², flaking may occurs in addition to much cracking of the dry coating layer, and printed images may be disturbed since the ink flows on the surface along the channels created by the cracking and makes this option undesirable.

The layer construction of the ink absorbing layers formed on a base material and the composition of each layer are not particularly restricted in the present invention. That is, two or more ink absorbing layers may be formed by applying an ink absorbing layer coating solution a multiple number of times on one or both surfaces of a base material. In this case, individual ink absorbing layers are formed to achieve the dry coating weight mentioned above. Now when coating solutions of identical components are applied a multiple number of times, the ink absorbing layer may appear to be one layer. In addition, when an ink absorbing layer is formed on one side of a base material in the present invention, a coating layer may be formed on the opposite side for the purpose of correcting curling or to improve transport properties.

In the present invention, the formation of an under layer between an ink absorbing layer and a base material is also preferred in order to improve the ink absorption and imaging quality of an inkjet recording medium. Inorganic pigments such as synthetic silica, alumina and alumna hydrates (alumina sol, colloidal alumina, pseudo boehmite and the like), aluminum silicate, magnesium silicate, magnesium carbonate, light calcium carbonate, heavy calcium carbonate, kaolin, talc, calcium sulfate, titanium dioxide, zinc oxide, zinc carbonate, calcium silicate, aluminum hydroxide and the like as well as organic white pigments such as styrene type plastic pigments, acrylic type plastic pigments, urea resin and the like may be used as the pigment used in the under layer. Of these, fine synthetic silica having an average particle diameter of 5 μm or smaller is most preferred. In addition, as the binder for an under layer, the same binders listed for said ink absorbing layer may be preferably used.

The suitable coating weight of an under layer may be decided according to the objects, but a dry coating weight range of from 5 g/m² to 30 g/m² is preferred in the present invention. When the dry coating weight is under 5 g m², the ink absorption by the coating layer may be uneven and printing property is adversely: affected due to difficulties encountered in covering the surface of a base material completely with the under layer as a coating layer. In addition, when the dry coating weight exceeds 30 g/m², the bonding strength between the ink absorbing layer and the base material reaches an impractical level and serious problems may occur due to peeling of the coating layer from the base material which is referred to as flaking.

In the present invention, the formation of a glossy layer having ink permeability is obtained by applying a cationic polymer dispersion to an ink absorbing layer to further improve the gloss and color development of the inkjet recording medium. The cationic polymer dispersion mentioned above is a dispersion of a fine, non cross-linked styrene-acrylic type polymer particles obtained through a copolymerization reaction having at least a cationic monomer, (meth)acrylamide, styrene and methyl methacrylate as the monomer components. The production method thereof is outlined below.

The monomer type and preferred weight ratios are from 2% by weight to 20% by weight of (meth)acrylamide, from 20% by weight to 60% by weight of styrene, from 20% by weight to 60% by weight of methyl methacrylate, from 2% by weight to 30% by weight of cationic monomer and, in addition, from 0% by weight to 20% by weight of another ethylenic monomer, and the ratio is adjusted within these ranges so the sum is 100%. However, the ratios shown above represents the ranges within which individual compounds are fed. As the cationic monomer used here, cationic vinyl monomers containing tertiary amines such as N,N-dimethyl aminoethyl (meth)acrylate, N,N-diethylaminoethyl (meth)acrylate, N,N-dimethylaminopropyl (meth) acrylate, N,N-dimethylamino-2-hydroxypropyl (meth)acrylate, N,N-dimethylaminopropyl (meth)acrylamide and the like may be cited. Furthermore, monomers containing quaternary ammonium salts such as (meth)acryloyloxy ethyltrimethyl ammonium chloride, (meth)acryloyloxy ethyldimethyl benzyl ammonium chloride, (meth)acryloyloxy ethyltriethyl ammonium chloride, (meth)acryloyloxy ethyldiethyl benzyl ammonium chloride, (meth)acryloyloxy propyltrimethyl ammonium chloride, (meth)acrylamide propyltrimethyl ammonium chloride, (meth)acrylamide propyldimethyl benzyl ammonium chloride, (meth)acrylamide propyldiethyl benzyl ammonium chloride, 2-hydroxy-3-(meth)acrylamide propyltrimethyl ammonium chloride and the like may be cited.

As other ethylenic monomers, low molecular weight esters such as ethyl (meth)acrylate, monomers containing a carboxyl group such as (meth)acrylic acid, itaconic acid and the like and monomers containing a sulfonic acid group such as styrene sulfonic acid and the like may be cited.

The synthesis of a cationic polymer dispersion in the present invention is conducted by mixing and dissolving (meth)acrylamide, the cationic monomers listed above and a chain transfer agent such as thioglycolic acid and the like in either a cationic or non-ionic aqueous emulsifier solution, dropping or mixing a mixture of styrene, methyl methacrylate and other ethylenic monomers to this aqueous solution, adding a cationic polymerization initiator while heating and agitating to allow polymerization to occur and neutralizing the reaction mixture upon completion of the polymerization reaction. Polymer dispersions containing dispersed polymer particles having an average particle diameter of from 100 nm to about 200 nm are obtained by suitably selecting various reaction conditions including the polymerization temperature. The polymer particles obtained through a polymerization using the composition in said range are polymer particles that do not form a film at room temperature and are not cross-linked. Therefore, when they are dried or treated without exposing to a temperature above the temperatures used in ordinary drying steps or subjected to undue heat of friction, they contain hydrophilic or cationic functional groups on the particle surface and can form an ink permeable glossy layer by maintaining voids between polymer particles. Now, the average particle diameter of the polymer particles may be measured using a dynamic light scattering photometer as is used to measure colloidal silica.

Here, “the fine polymer particles in said polymer dispersion being present while maintaining a particulate shape” refers to individual polymer particles not losing the shape of fine polymer particles dispersed in said polymer dispersion and, when examining the surface of a glossy layer after a film is formed, not losing the boundary area between polymer particles due to the fusion of adjacent polymer particles. Under this condition, the surfaces of adjacent polymer particles are in contact with each other or are connected in spots, but the boundary is not lost due to the fusion of the surfaces, and small voids are left in the boundary area between particles. The presence of the voids is believed to impart good ink absorption. On the other hand, the case in which “fine polymer particles do not retain particulate shape” refers, for example, to the cases in which polymer particles are fused with adjacent polymer particles and the boundary is obliterated due to the boundary areas of both particles practically merging. In such cases, the boundaries disappear and a uniform surface is obtained due to individual particles fusing when, for example, the surface of a glossy layer is examined after a film is formed.

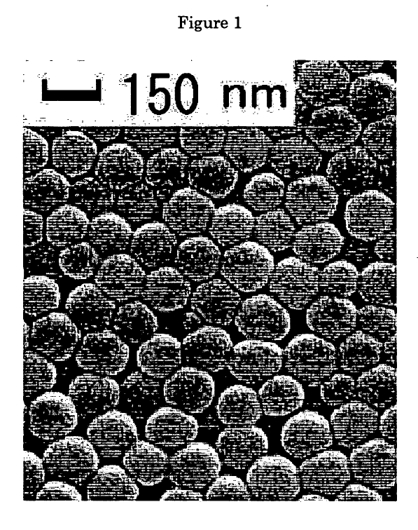

FIG. 1 shows a photograph illustrating an example of a glossy layer of the present invention when viewed from the surface. In this figure, fine polymer particles that were originally spherical are deformed into roughly hexagonal shapes (a shape that packs densely) in the top left region of the figure, and adjacent particles are in contact with each other through a small voids. The boundary between particles does not disappear even in this case. In addition, fine polymer particles in the lower region of the figure retain the spherical shape observed at the time of dispersion and are in contact with adjacent particles at spots. In this case, the voids on the boundaries between particles is slightly larger. A boundary is clearly observed between particles even in this case.

When synthesizing a cationic polymer dispersion of the present invention, monomers containing at least two carbon-carbon double bonds per molecule, that is, monomers capable of cross-linking and an emulsifier are not used, and polymer particles having no cross-linking are obtained. When polymer particles undergo cross-linking, the surface layer sections of polymer particles, in particular, harden, making leveling while drying the coating more difficult. Therefore, the coating layer surface is less smooth, high gloss is almost impossible to achieve and it is difficult to obtain a desired high gloss inkjet recording medium. In addition, the glass transition temperature (Tg) of a polymer can be calculated by Fox's formula shown below using the glass transition temperatures (Tgn: the unit in Fox's formula is absolute temperature K) of the homopolymers of the individual monomers contained in the polymer and the weight fractions (wn) of the individual monomers.
1/Tg=w1/Tg1+w2/Tg2+ . . . +wn/Tgn

In an effort to manufacture an inkjet recording medium having excellent ink absorption of the present invention using the cationic polymer dispersion described above, an under layer is formed on said base material when necessary, an undercoated paper is prepared by applying a colloidal silica over the under layer and drying it to form an ink absorbing layer and next a glossy layer is formed by applying on the surface of said undercoated paper a mixed solution containing the cationic polymer dispersion described above and, when necessary, 0% by weight to 10% by weight of a hydrophilic binder used to bond the cationic polymer as described above.

A glossy layer of the present invention is preferably applied thinly and uniformly and is applied and dried to have a single side coating weight calculated in terms of the solid content of from 0.3 g/m² to about 3.0 g/m². The gloss improves even when the coating weight is low when the layer is applied uniformly, but a uniform fine polymer particle layer may not be formed when the coating weight is less than 0.3 g/m². On the contrary, when the coating weight is too large, the ink absorption decreases since said voids between fine polymer particles may not be maintained.

Commonly used applicators such as various blade coaters, roll coaters, air knife coaters, bar coaters, gate roll coaters, curtain coaters, short dwell coaters, gravure coaters, flexographic gravure coaters, size presses and the like may be used on-machine or off-machine in the present invention in order to form an under layer, an ink absorbing layer or a glossy layer on the surface of a base material or an ink absorbing layer.

In the present invention, a coated surface may be surface treated using calendering apparatus such as machine calendering, super calendering, soft calendering and the like before or after individual layers are applied, and the gloss is improved even more by the surface treatment. However, the selection of pressures and temperatures that do not melt the fine polymer particles and convert them into a film (that is, to cause the voids between particles to disappear) becomes important, particularly for the glossy layer. In the present invention, conducting a calendering treatment on the surface of the glossy layer at a temperature of from room temperature to 40° C. is preferred. Therefore, the temperature becomes the temperature of the environment (room temperature) when the temperature during a calendering treatment is not particularly managed, and the temperature may be managed at a designated temperature from room temperature 40° C. A calendering treatment is not necessary since the ink absorption of an inkjet recording medium tends to decline when a calendering treatment is conducted and excellent gloss is achieved at the point when a cationic polymer dispersion is applied on an ink absorbing layer and dried in an inkjet recording medium of the present invention. Eliminating any calendering treatment is preferred since an inkjet recording medium having excellent ink absorption can be obtained without it.

The reason why an inkjet recording medium having excellent gloss and good ink absorption as well as good image quality with excellent color development and color reproducibility is obtained in the present invention is not clearly understood, but the following inferences are drawn. That is, the glass transition temperature of a polymer obtained by copolymerizing a major component comprising styrene and methyl methacrylate is sufficiently higher than room temperature, and the copolymerized polymer is present on an ink absorbing layer while maintaining a particulate shape when the coating layer is dried. Said particles are spot bonded amongst themselves to form a layered structure containing voids which are presumed to facilitate ink penetration. Furthermore, an even better gloss improving effect is achieved by allowing a higher proportion of styrene monomer to undergo copolymerization. In addition, hydrophilic functional groups are present on the surfaces of particles since a water soluble (meth)acrylamide is allowed to copolymerize, and an ink penetrates the area between said particles in an ink medium very quickly. Furthermore, a polymer dispersion containing numerous cationic functional groups on a particle surface can be synthesized when a cationic monomer containing said tertiary amines or quaternary ammonium salts is copolymerized and also when a cationic or non-ionic emulsifier and a cationic polymerization initiator are used during the polymerization. The presumption is that only anionic dye molecules can be efficiently fixed in the vicinity of a boundary between said particles and an ink absorbing layer, and images having excellent color development and color reproducibility can be obtained due to these reasons.

On the other hand, the particle diameter of colloidal silica is very small, and the surface of an ink absorbing layer is very smooth. Furthermore, the average particle diameter of the cationic polymer particles applied on said ink absorbing layer is extremely small, from about 100 nm to 200 nm, and light in the short wavelength region of visible light is practically not scattered. Therefore, the random reflection of light is inhibited, and an inkjet recording medium having high gloss can be obtained.

### EXAMPLES

The present invention is explained in further detail by presenting specific examples below, but the present invention is not limited by these examples. In addition, the terms “parts” and “%” described below refer to “parts by weight” and “% by weight” unless otherwise noted.

### Synthesis Example 1

### A Dispersion of Fine Cationic Polymer Particles

Three hundred and ten parts of water, 9 parts of 30% octadecyl trimethyl ammonium chloride [cation AB: a trade name of NOF CORPORATION, cationic emulsifier (does not contribute to the reaction)], 32 parts of a 50% aqueous acrylamide solution, 1 part of thioglycolic acid, 14 parts of 80% methacryloyloxyethyl trimethyl ammonium chloride, 86 parts of styrene and 46 parts of methyl methacrylate were added to a reactor equipped with an agitator, a dropping addition tank and a thermometer, and the contents were heated to 60° C. while bubbling in nitrogen gas. Next, 12 parts of a 4% aqueous solution of 2,2-azo-bis-2-amidinopropane dihydrochloride (V-50: a trade name of Wako Pure Chemical Industries, Ltd.) was added to initiate a polymerization. An exothermic polymerization occurred, the reaction mixture was maintained at 85° C. for an hour, 2 parts of a 4% aqueous solution of 2,2-azo-bis-2-amidinopropane dihydrochloride was added, and the reaction mixture was maintained at 80° C. for 2 hours to conclude the polymerization. The reaction mixture was diluted with water, and a dispersion of fine cationic polymer particles having a viscosity of 10 mPa·s, concentration in terms of solids content of 28%, an average particle diameter of 140 nm and a glass transition temperature of 103° C. was obtained.

### Synthesis Example 2

### A Dispersion of Fine Cationic Polymer Particles

Three hundred and thirty parts of water, 6.5 parts of acetic acid, 6.4 parts of 30% cetyl trimethyl ammonium chloride (quartamin 60W: a trade name of Kao Corporation, cationic emulsifier), 16 parts of a 50% aqueous acrylamide solution, 16 parts of N,N-dimethyl aminoethyl methacrylate, 1 part of thioglycolic acid, 64 parts of styrene, 61 parts of methyl methacrylate and 11 parts of N-butyl acrylate were added to a reactor equipped with an agitator and a thermometer, and the mixture were heated to 60° C. while bubbling in nitrogen gas. Next, 4.2 parts of a 6% aqueous solution of 2,2-azo-bis-2-amidinopropane dihydrochloride (V-50: a trade name of Wako Pure Chemical Industries, Ltd.) was added to initiate a polymerization. An exothermic polymerization occurred and the reaction mixture was maintained at 85° C. for an hour after which 3.7 parts of 3% 2,2-azo-bis-2-amidinopropane dihydrochloride aqueous solution was added and the reaction mixture was agitated at 80° C. for an hour. The reaction mixture was cooled and diluted with water, and a dispersion of fine cationic polymer particles having a viscosity of 160 mPa·s, concentration in terms of solids content of 30%, an average particle diameter of 140 nm and a glass transition temperature of 77° C. was obtained.

### Synthesis Example 3

### A Dispersion of Fine Cationic Polymer Particles

Three hundred parts of water, 0.5 part of acetic acid, 9 parts of 30% cetyl trimethyl ammonium chloride (quartamin 60W: a trade name of Kao Corporation, cationic emulsifier), 16 parts of a 50% aqueous acrylamide solution, 1 part of thioglycolic acid and 20 parts of 80% methacryloyloxyethyl trimethyl ammonium chloride were added to a reactor equipped with an agitator, a droppnig addition tank and a thermometer, and the mixture were heated to 80° C. while bubbling in nitrogen gas. In this mixture, 136 parts of a mixture of 78 parts of styrene, 42 parts of methyl methacrylate and 16 parts of n-butyl acrylate was added by drops over 2 hours while simultaneously adding by drops 16 parts of a 4% aqueous solution of 2,2-azo-bis-2-amidinopropane dihydrochloride (V-50: a trade name of Wako Pure Chemical Industries, Ltd.). The reaction mixture was maintained for 2 hours at 85° C., and then 2 parts of 4% 2,2-azo-bis-2-amidinopropane dihydrochloride aqueous solution was added after which the reaction mixture was maintained at 80° C. for 2 hours to conclude the polymerization. The reaction mixture was diluted with water, and a dispersion of fine cationic polymer particles having a viscosity of 18 mPa·s, concentration in terms of solids content of 33%, an average particle diameter of 120 nm and a glass transition temperature of 75° C. was obtained.

### Synthesis Example 4

### A Dispersion of Fine Cationic Polymer Particles

Three hundred and ten parts of water, 6.4 parts of 30% lauryl trimethyl ammonium chloride (cation BB: a trade name of NOF CORPORATION, a cationic emulsifier), 25.6 parts of 50% aqueous acrylamide solution, 0.7 part of thioglycerol, 40 parts of 60% methacryloyloxyethyl dimethylbenzyl ammonium chloride, 55 parts of styrene and 68 parts of methyl methacrylate were added to a reactor equipped with an agitator, a dropping addition tank and a thermometer, and the mixture were heated to 60° C. while bubbling in nitrogen gas. In this mixture, 12 parts of a 4% aqueous solution of 2,2-azo-bis-2-amidinopropane dihydrochloride (V-50: a trade name of Wako Pure Chemical Industries, Ltd.) was added to initiate a polymerization. An exothermic polymerization occurred and the reaction mixture was maintained at 85° C. for an hour after which 2 parts of a 4% aqueous solution of 2,2-azo-bis-2-amidinopropane dihydrochloride was added and the reaction mixture was maintained at 80° C. for 2 hours to conclude the polymerization. The reaction mixture was diluted with water, and a dispersion of fine cationic polymer particles having a viscosity of 22 mPa·s, concentration in terms of solids content of 26%, an average particle diameter of 150 nm and a glass transition temperature of 98° C. was obtained.

### Comparative Synthesis Example 1

### A Dispersion of Fine Polymer Particles

Three hundred parts of water, 9 parts of allylnonylphenol polyoxyethylene oxide as an anionic reactive emulsifier (EO addition 10 moles), ammonium sulfate ester (Aquaron HS-10: a trade name of Dai-ichi Kogyo Seiyaku. Co., Ltd.), 25 parts of a 50% aqueous acrylamide solution and 1 part of thioglycolic acid, a water soluble chain transfer agent, were added to a reactor equipped with an agitator, a dropping addition tank and a thermometer, and the mixture were heated to 75° C. while bubbling in nitrogen gas. One hundred and forty parts of styrene, 86 parts of methyl methacrylate, 10 parts of ethyl acrylate and 1 part of acrylic acid were added by drops over 2 hours while simultaneously adding by drops 25 parts of a 2% aqueous ammonium persulfate solution over 2 hours and 15 minutes. Next, the reaction mixture was maintained at 85° C. for 2 hours to conclude the polymerization, and aqueous ammonia was then added to neutralize the reaction mixture to pH 8.0. A dispersion of fine anionic polymer particles having a viscosity of 110 mPa·s, concentration in terms of solids content of 38%, an average particle diameter of 82 nm and a glass transition temperature of 97° C. was obtained.

### Comparative Synthesis Example 2

### A Dispersion of Fine Cationic Polymer Particles

Three hundred and ten parts of water, 6.4 parts of 30% lauryl trimethyl ammonium chloride (Cation BB: a trade name of NOF CORPORATION, a cationic emulsifier), 25.6 parts of a 50% aqueous acrylamide solution, 0.7 part of thioglycerol, 40 parts of 60% methacryloyloxyethyl dimethylbenzyl ammonium chloride, 55 parts of styrene, 10 parts of divinylbenzene (a monomer that can crosslink) and 68 parts of methyl methacrylate were added to a reactor equipped with an agitator, a dropping addition tank and a thermometer, and the mixture were heated to 60° C. while bubbling in nitrogen gas. In this mixture, 12 parts of a 4% aqueous solution of 2,2-azo-bis-2-amidinopropane dihydrochloride (V-50: a trade name of Wako Pure Chemical Industries, Ltd.) was added to initiate a polymerization. An exothermic polymerization occurred and the reaction mixture was maintained at 85° C. for an hour after which 2 parts of a 4% aqueous solution of 2,2-azo-bis-2-amidinopropane dihydrochloride was added, and the reaction mixture was maintained at 80° C. for 2 hours to conclude the polymerization. The reaction mixture was diluted with water, and a dispersion of fine cationic polymer particles having a viscosity of 15 mPa·s, concentration in terms of solids content of 29%, an average particle diameter of 130 nm and a glass transition temperature of 98° C. was obtained.

### Example 1

Base Material

Fifteen parts of calcium carbonate, 1 part of cationized starch, 0.3 part of anionized polyacrylamide and 0.5 part of alkyl ketene dimer were added to a pulp obtained by beating a 100% bleached hard wood kraft pulp and adjusting a degree of beating to 350 ml. The mixture was formed into paper using a Fourdrinier paper machine and dried, and subjected to a machine calendering treatment to manufacture a base material weighing 157 g/m².

Under Layer

Dilution water was added to 100 parts of synthetic amorphous silica (Finesil X-37B: a trade name of Tokuyama Corp.), 40 parts of poly(vinyl alcohol) (PVA-117: a trade name of KURARAY Co., Ltd.), 5 parts of styrene butadiene latex (LX438C: a trade name of ZEON Corporation.), 2 parts of a sizing agent (Polymaron 360: a trade name of Arakawa Chemical Industries, Ltd.) and 5 parts of a dye fixing agent (PAS-H-10L: a trade name of Nitto Boseki Co., Ltd.), the mixture was agitated and to obtain a coating of concentration in terms of solid content of 20%. This coating was applied to said base material using a bar blade coater to achieve a coating weight of 12 g/m² and obtain a coated paper having a coating layer that is an under layer.

Ink Absorbing Layer

A coating of concentration in terms of solid content of 16% was obtained by mixing 100 parts of a colloidal silica (Snowtex UP: a trade name of Nissan Chemical Industries, Ltd.) having an average primary particle diameter of 15 nm, an average secondary particle diameter of 70 nm and containing chain shaped secondary particles and 6 parts of a dye fixing agent (PF700: a trade name of SHOWA HIGHPOLYMER CO., LTD.) and was applied to the base material coated with an under layer coating manufactured as described above using a bar blade coater to achieve a coating weight of 5 g/m².

Glossy Layer

A coating solution of concentration in terms of solid content of 10% obtained by adding 100 parts in terms of solid content of the cationic polymer dispersion prepared in said Synthesis Example 1 and 2 parts of poly(vinyl alcohol) (PVA-217: a trade name of KURARAY Co., Ltd.) was applied to the ink absorbing layer formed on said base material using a bar blade coater, and dried to achieve a coating weight of 1.0 g/m² to obtain the inkjet recording medium of Example 1.

### Example 2

Base Material

A base material was manufactured in the manner described in Example 1.

Under Paper

A coated paper containing an under layer as a coating layer was obtained in the manner described in Example 1.

Ink Absorbing Layer

An ink absorbing layer was formed in the manner described in Example 1 with the exception that a colloidal silica (Snowtex PS-L: a trade name of Nissan Chemical Industries, Ltd.) having an average primary particle diameter of 40 nm, an average secondary particle diameter of 150 nm and containing pearl necklace shaped secondary particles (a chain forming a circle) was used in place of the colloidal silica used in Example 1.

Glossy Layer

The inkjet recording medium of Example 2 was obtained in the manner described in Example 1 with the exception that the cationic polymer dispersion prepared in said Synthesis Example 2 was used in place of the cationic polymer dispersion used in Example 1.

### Example 3

Base Material

A base material was manufactured in the manner described in Example 1.

Ink Absorbing Layer

An ink absorbing layer was formed in the manner described in Example 1 with the exception that the coating weight was 10 g/m². An under layer was not formed.

Glossy Layer

The inkjet recording medium of Example 3 was obtained in the manner described in Example 1.

### Example 4

An inkjet recording medium was manufactured in the manner described in Example 1 and was calendered in a room maintained at 30° C. air temperature using a soft nip calendering machine at a line pressure of 980.7 N/cm to obtain the inkjet recording medium of Example 4. In this case, the surface temperature of the calender rolls in contact with the glossy layer was 35° C.

### Example 5

An inkjet recording medium was manufactured in the manner described in Example 1 and was calendered using a soft nip calendering machine at a line pressure of 980.7 N/cm to obtain the inkjet recording medium of Example 5. In this case, the calender rolls coming in contact with the glossy layer were heated, and the surface temperature was 45° C.

### Example 6

Base Material

A base material was manufactured in the manner described in Example 1.

Under Layer

Dilution water was added to 100 parts of synthetic amorphous silica (Nipgel AY-601: a trade name of TOSOH SILICA CORPORATION), 20 parts of poly(vinyl alcohol) (PVA-117: a trade name of KURARAY Co., Ltd.), 15 parts of ethylene vinyl acetate (BE7000: a trade name of CHUO RIKA KOGYO CORPORATION), 2 parts of a sizing agent (SS335: a trade name of SEIKO PMC CORPORATION) and 5 parts of a dye fixing agent (UNISENCE CP-103: a trade name of SENKA corporation), the mixture was agitated and to obtain a coating of concentration in terms of solid content of 20%. This coating was applied to said base material using a bar blade coater to achieve a coating weight of 12 g/m² and obtain a coated paper having a coating layer that is an under layer.

Ink Absorbing Layer

An ink absorbing layer was formed in the manner described in Example 1 with the exception that a colloidal silica (Snowtex HS-M-20: a trade name of Nissan Chemical Industries, Ltd.) having an average primary particle diameter of 30 nm, an average secondary particle diameter of 280 nm and containing cluster shaped secondary particles was used in place of the colloidal silica used in Example 1.

Glossy Layer

The inkjet recording medium of Example 6 was obtained in the manner described in Example 1 with the exception that the cationic polymer dispersion prepared in said Synthesis Example 3 was used in place of the cationic polymer dispersion used in Example 1 and the coating weight of the glossy layer was 2.0 g/m².

### Example 7

Base Material

Ten parts of talc, 1.0 part of aluminum sulfate, 0.1 part of a synthetic sizing agent and 0.3 part of a yield improving agent were added to a pulp obtained by beating a 100% bleached hard wood kraft pulp and adjusting a degree of beating to 400 ml. The mixture was formed into paper using a conventional Fourdrinier paper machine and dried, and a base material weighing 100 g/m² was manufactured after applying an oxidized starch using a sizing press to achieve dry coating weight of each side of 1.5 g/m², drying the coating and conducting a machine calendering treatment.

Under Layer

Dilution water was added to 100 parts of synthetic amorphous silica (Sylojet P-409: a trade name of Grace Japan K.K.), 30 parts of poly(vinyl alcohol) (PVA-117: a trade name of KURARAY Co., Ltd.), 5 parts of styrene butadiene latex (LX438C: a trade name of ZEON Corporation.), 5 parts of ethylene vinyl acetate (BE7000: a trade name of CHUO RIKA KOGYO CORPORATION), 2 parts of a sizing agent (Polymaron 360: a trade name of Arakawa Chemical Industries, Ltd.) and 8 parts of a dye fixing agent (Polyfix 700: a trade name of SHOWA HIGHPOLYMER CO., LTD.), and the mixture was agitated to obtain a coating containing 20% solids. This coating was applied to said base material using a bar blade coater to achieve a coating weight of 12 g/m² to obtain a coated paper containing a coating layer that is an under layer.

Ink Absorbing Layer

A coating of concentration in terms of solid content of 16% obtained using a core-shell type inorganic-organic hybrid emulsion (#85: a trade name of MIZUTANI PAINT MFG, CO., LTD.) obtained by coating spherical colloidal silica having an average primary particle diameter of 50 nm using an acrylic emulsion, and 6 parts of a dye fixing agent (EPOMIN P1000: a trade name of NIPPON SHOKUBAI CO., LTD.) was applied using a bar blade coater to the base material coated with an under layer coating manufactured as described above to achieve a coating weight of 3 g/m².

Glossy Layer

The inkjet recording medium of Example 7 was obtained by forming a glossy layer in the manner described in Example 1 with the exception that the cationic polymer dispersion prepared in said Synthesis Example 4 was used in place of the cationic polymer dispersion used in Example 1.

### Comparative Example 1

The inkjet recording medium of Comparative Example 1 was obtained in the manner described in Example 1 with the exception that the anionic polymer dispersion prepared in said Comparative Synthesis Example 1 in place of the cationic polymer dispersion used in Example 1 was used as the glossy layer.

### Comparative Example 2

The inkjet recording medium of Comparative Example 2 was obtained in the manner described in Example 1 with the exception that a cationic acrylic resin emulsion (NM-11: a trade name of Mitsui Chemicals, Inc.) (average particle diameter 125 nm, glass transition temperature −20 degrees, did not contain styrene as a monomer) in place of the cationic polymer dispersion used in Example 1 was used as the glossy layer.

### Comparative Example 3

Base Material and Under Paper

An under paper was obtained by forming an under layer in the same manner described in previous Examples using the identical base material used in Example 1.

Ink Absorbing Layer

An ink absorbing layer was formed to achieve a dry coating weight of 5 g/m² using a bar blade coater and the under layer coating used in Example 1 as the coating solution for the ink absorbing layer. The synthetic amorphous silica (Finesil X-37B: a trade name of Tokuyama Corp.), in the under layer coating had a particle diameter of 3,700 nm (3.7 μm).

Glossy Layer

The inkjet recording medium of Comparative Example 3 was obtained in the manner described in Example 1 by applying a glossy layer over the ink absorbing layer described above.

### Comparative Example 4

An inkjet recording medium was manufactured in the same manner described in Example 1 and was calender treated using a soft nip calender machine at a line pressure of 980.7 N/cm to obtain the inkjet recording medium of Comparative Example 4. In this case, the calender rolls coming in contact with the glossy layer were heated, and the heating was adjusted to achieve a surface temperature of 80° C. The glossy layer surface of the inkjet recording medium was examined using a reflective electron microscope. The glossy layer comprised a resin layer having a uniform surface, the layer did not contain voids and fine polymer particles retaining particulate shapes were not observed.

### Comparative Example 5

The inkjet recording medium of Comparative Example 5 was obtained in the manner described in Example 1 with the exception that the cationic polymer dispersion prepared in said Comparative Synthesis Example 2 was used as the glossy layer in place of the cationic polymer dispersion used in Example 1.

<Evaluation Methods>

The recording media obtained in Examples 1-7 and Comparative Examples 1-5 described above were evaluated according to the methods described below. In each category, an evaluation of Δ or better signifies a practical value.

In evaluating inkjet printing, a PM-9000C manufactured by Seiko Epson Corp. was used as the inkjet printer in the “semigloss photo paper•neat” mode.

<White Paper Gloss>

75° specular gloss of a coated surface was measured according to JIS-P-8142 using a gloss meter (Murakami Color Research Laboratory, GM-26 for 75°).
O: 75° specular gloss is 60% or greater.
Δ: 75° specular gloss is 50% or greater but under 60%.
X: 75° specular gloss is under 50%.
   <Color Development>

Solid images in black, cyan, magenta and yellow were printed using “Excel”, a spreadsheet software. A printed sample was left standing for 24 hours in a constant temperature and humidity chamber, and the optical density of each color was measured using a Macbeth Densitometer (RD915: a trade name of Gretag Macbeth AG.). The sums of measured values were used for the evaluation.
O: The sum of four colors was 7.5 or greater.
Δ: The sum of four colors was 7.0 or greater but under 7.5.
X: The sum of four colors was under 7.0.
   <Ink Absorption>

Red and green solid images and blue and yellow solid images were printed adjacent to each other, and the boundaries were comprehensively evaluated for bleeding.
O: The boundary was clear, and no bleeding was observed.
Δ: The boundary was somewhat blurred, but no bleeding was observed.
X: The boundary was blurred, and bleeding was observed.
   <Color Reproducibility>

The L*a*b* values of solid image areas in cyan, magenta, yellow, red, green and black were measured using a spectro-colorimeter (NF999: a trade name of Nippon Denshoku Kogyo K.K.) with a D65 light source and a ten degree field of vision. For each color (six colors), the value a* was plotted on the x axis, and the value b* was plotted on the y axis. The area (Gamut area) of the hexagonal area having the six colors as apexes was measured and used for the evaluation. Now, red is ordinarily positioned in the first quadrant bound by positive x and positive y axes, yellow on the upper y axis (y>0), green in the second quadrant bound by negative X and positive Y axes, cyan in the third quadrant bound by negative X and negative Y axes, blue on the lower y axis (y<0) and magenta in the fourth quadrant bound by positive X and negative Y axes.
O: The Gamut area is 11,000 or greater.
Δ: The Gamut area is 9,000 or greater but under 11,000.
X: The Gamut area is under 9,000.

The evaluation results are shown in Table 1, 2. No problems were encountered in practice when the evaluation results in the table were shown by O or Δ, but practical problems were encountered when the evaluation results were shown by X. Now, in the table, the “silica average particle diameter” refers to the secondary particle diameter when primary particles have coagulated into secondary particles and to the primary particle diameter when the primary particles (a core/shell structure) remained without coagulating.

TABLE 1

| | | | Example 1 | Example 2 | Example 3 | Example 4 | Example 5 | Example 6 | Example 7 |
|---|---|---|---|---|---|---|---|---|---|
| Under layer | Type | | X37B | X37B | — | X37B | X37B | AY601 | P409 |
| | Partricle diameter (μm) | | 3.7 | 3.7 | — | 3.7 | 3.7 | 6.0 | 9.0 |
| | Coating weight (g/m²) | | 12 | 12 | — | 12 | 12 | 12 | 12 |
| Ink-absorbing | Type | | UP | PS-L | UP | UP | UP | HS-M-20 | #85 |
| layer | Shape | | Chain | Pearl | Chain | Chain | Chain | Cluster | Spherical |
| | | | | necklace | | | | | |
| | Average particle diameter of silica | | 70 | 150 | 70 | 70 | 70 | 280 | 50 |
| | (nm) | | | | | | | | |
| | Coating weight (g/m²) | | 5 | 5 | 10 | 5 | 5 | 5 | 3 |
| Glossy layer | Polymer particles average particle | | 140 | 140 | 140 | 140 | 140 | 120 | 150 |
| | diameter (nm) | | | | | | | | |
| | Cationic monomer type | | Synthesis | Synthesis | Synthesis | Synthesis | Synthesis | Synthesis | Synthesis |
| | | | Example 1 | Example 2 | Example 1 | Example 1 | Example 1 | Example 3 | Example 4 |
| | Composition | Cationic monomer | 6.9 | 9.8 | 6.9 | 6.9 | 6.9 | 9.7 | 14.7 |
| | | (Meth)acrylamide | 9.8 | 4.9 | 9.8 | 9.8 | 9.8 | 4.9 | 7.9 |
| | | Styrene | 52.6 | 39.2 | 52.6 | 52.6 | 52.6 | 47.4 | 33.7 |
| | | Methylmethacrylate | 28.1 | 37.4 | 28.1 | 28.1 | 28.1 | 25.5 | 41.7 |
| | | Crosslinking agent | 0 | 0 | 0 | 0 | 0 | 0 | 0 |

| | | | | | | | | |
|---|---|---|---|---|---|---|---|---|
| | Coating weight (g/m²) | 1 | 1 | 1 | 1 | 1 | 2 | 1 |
| Calendering | Type | None | None | None | Softnip | Softnip | None | None |
| treatment | | | | | calendering | calendering | | |
| | Treatment temperature (° C.) | — | — | — | 30 | 45 | — | — |
| Evalution | White paper gloss | ◯ | ◯ | ◯ | ◯ | ◯ | ◯ | ◯ |
| | Color development | ◯ | Δ | ◯ | ◯ | ◯ | ◯ | ◯ |
| | Ink absorbance | ◯ | ◯ | Δ | ◯ | Δ | ◯ | Δ |
| | Color reproducibility | ◯ | ◯ | ◯ | ◯ | Δ | ◯ | Δ |

TABLE 2

| | | | Comparative | Comparative | Comparative | Comparatvie | Comparative |
|---|---|---|---|---|---|---|---|
| | | | Example 1 | Example 2 | Example 3 | Example 4 | Example 5 |
| Under layer | Type | | X37B | X37B | X37B | X37B | X37B |
| | Particle diameter (μm) | | 3.7 | 3.7 | 3.7 | 3.7 | 3.7 |
| | Coating weight (g/m²) | | 12 | 12 | 17 | 12 | 12 |
| Ink-absorbing | Type | | UP | UP | X37B | UP | UP |
| layer | Shape | | Chain | Chain | Amorphous | Chain | Chain |
| | Average particle diameter of silica | | 70 | 70 | 3700 | 70 | 70 |
| | (nm) | | | | | | |
| | Coating weight (g/m²) | | 5 | 5 | 5 | 5 | 5 |
| Glossy layer | Polymer particles average particle | | 82 | 125 | 140 | 140 | 130 |
| | diameter (nm) | | | | | | |
| | Cationic monomer type | | Comparative | NM-11 | Synthesis | Synthesis | Comparative |
| | | | Synthesis | | Example 1 | Example 1 | Synthesis |
| | | | Example 1 | | | | Example 2 |
| | Composition | Cationic monomer | 0 | Does not | 6.9 | 6.9 | 13.9 |
| | | (Meth)acrylamide | 4.8 | contain | 9.8 | 9.8 | 7.4 |
| | | Styrene | 53.8 | styrene | 52.6 | 52.6 | 31.8 |
| | | Methylmethacrylate | 33.1 | | 28.1 | 28.1 | 39.3 |
| | | Crosslinking agent | 0 | | 0 | 0 | 0.7 |

| | | | | | | |
|---|---|---|---|---|---|---|
| | Coating weight (g/m²) | 1 | 1 | 1 | 1 | 1 |
| Calendering | Type | None | None | None | Softnip | None |
| treatment | | | | | calendering | |
| | Treatment temperature (° C.) | — | — | — | 80 | — |
| Evaluation | White paper gloss | ◯ | Δ | X | ◯ | ◯ |
| | Color development | Δ | ◯ | X | Δ | X |
| | Ink absorbsnce | ◯ | X | ◯ | X | X |
| | Color reproducibility | X | X | X | X | X |

The data presented in Table 1, 2 clearly indicate that the inkjet recording media of individual examples had high gloss and good ink absorption as well as particularly excellent color development and color reproducibility.

On the other hand, when a fine anionic polymer particle dispersion was used in a glossy layer as in Comparative Example 1, white paper gloss and ink absorption were good but the color reproducibility was particularly poor.

In addition, when a fine polymer particle dispersion containing no styrene was used in a gloss layer as in Comparative Example 2 or a high temperature calendering treatment was conducted as in Comparative Example 4, white paper gloss was relatively good but the voids between particles was practically nonexistent due to fusion and film formation of the polymer in the glossy layer by heat at the time the glossy layer was dried or calendered, and the resulting ink absorption was particularly poor.

Furthermore, when an ink absorbing layer containing not colloidal silica but synthetic amorphous silica having a large particle diameter present as the major components as in Comparative Example 3, white paper gloss was considerably lower and color development and color reproducibility were poor. Therefore, when fine inorganic particles having an average particle diameter of 500 nm or more were used in an ink absorbing layer, a high gloss inkjet recording medium could not be obtained because clearly defined texture was present on the glossy layer surface.

In addition, when cross-linked fine polymer particles were used in a glossy layer as in Comparative Example 5, none of the qualities, except for gloss, achieved the target. The reason for this is not clearly understood, but the results were attributed to the surface properties of the fine polymer particles changing through cross-linking.

The results presented above prove that the inkjet recording medium obtained according to the present invention has not only high gloss and good ink absorption but also excellent color development, excellent color reproducibility and good image quality.

An inkjet recording medium having high gloss and good ink absorption as well as excellent color development, excellent color reproducibility and good image quality can be obtained by the present invention.

1. An inkjet recording medium containing an ink absorbing layer the main component of which are fine inorganic particles having an average particle diameter of from 10 nm to 500 nm on a base material and a glossy layer obtained by coating a polymer dispersion over said ink absorbing layer wherein said polymer dispersion is a dispersion of fine, non cross-linked styrene-acrylic type polymer particles obtained by a copolymerization reaction of monomer components containing at least a cationic monomer, (meth)acrylamide, styrene and methyl methacrylate, said glossy layer is formed by having the fine polymer particles in said polymer dispersion present in said ink absorbing layer maintain their particulate shapes.

2. The inkjet recording medium described in claim 1 wherein the average particle diameter of the fine styrene-acrylic type polymer particles in said polymer dispersion is from 100 nm to 200 nm.

3. The inkjet recording medium described in claim 1 wherein said fine inorganic particles comprise a colloidal silica obtained by the coagulation of multiple numbers of spherical colloidal silica particles having a primary particle diameter of from 10 nm to 100 nm while dispersed in a coating solution that is used to form said ink absorbing layer.

4. The inkjet recording medium described in claim 1 wherein 75 degree specular gloss is 50% or more for said glossy layer surface.

5. The inkjet recording medium described in claim 1 wherein an under layer comprising synthetic silica and a hydrophilic binder is formed between said base material and said ink absorbing layer.

6. The inkjet recording medium described in claim 2 wherein said polymer dispersion contains, as the monomer component, from 2% by weight to 30% by weight of said cationic monomer.

7. An inkjet recording medium manufactured by a process which comprises forming an ink absorbing layer on the surface of a base material or on the surface of an underlayer comprising fine synthetic silica particles and a hydrophilic binder on the base material, wherein the main component of the ink absorbing layer is fine inorganic particles having an average particle diameter of from 10 nm to 500 nm on said under layer; forming a glossy layer on said ink absorbing layer by applying and drying a polymer dispersion that is a dispersion of fine, non cross-linked styrene-acrylic type polymer particles obtained by a copolymerization reaction of monomer components containing at least a cationic monomer, (meth)acrylamide, styrene and methyl methacrylate; and conducting a soft calendering treatment or a machine calendering treatment on said glossy layer surface at a temperature of from room temperature to 40° C.

8. An inkjet recording medium manufactured by a process which comprises the steps of: forming an ink absorbing layer on the surface of a base material or on the surface of an underlayer comprising fine synthetic silica particles and a hydrophilic binder on the base material, wherein the main component of the ink absorbing layer is fine inorganic particles having an average particle diameter of from 10 nm to 500 nm on said under layer; forming a glossy layer on said ink absorbing layer by applying and drying a polymer dispersion that is a dispersion of fine, non cross-linked styrene-acrylic type polymer particles obtained by a copolymerization reaction of monomer components containing at least a cationic monomer, (meth)acrylamide, styrene and methyl methacrylate; without conducting a calendering treatment on said glossy layer surface.

9. The inkjet recording medium described in claim 2 wherein said fine inorganic particles comprise a colloidal silica obtained by the coagulation of multiple numbers of spherical colloidal silica particles having a primary particle diameter of from 10 nm to 100 nm while dispersed in a coating solution that is used to form said ink absorbing layer.

10. The inkjet recording medium described in claim 2 wherein 75 degree specular gloss is 50% or more for said glossy layer surface.

11. The inkjet recording medium described in claim 3 wherein 75 degree specular gloss is 50% or more for said glossy layer surface.

12. The inkjet recording medium described in claim 9 wherein 75 degree specular gloss is 50% or more for said glossy layer surface.

13. The inkjet recording medium described in claim 2 wherein an under layer comprising synthetic silica and a hydrophilic binder is formed between said base material and said ink absorbing layer.

14. The inkjet recording medium described in claim 3 wherein an under layer comprising synthetic silica and a hydrophilic binder is formed between said base material and said ink absorbing layer.

15. The inkjet recording medium described in claim 9 wherein an under layer comprising synthetic silica and a hydrophilic binder is formed between said base material and said ink absorbing layer.

16. The inkjet recording medium described in claim 4 wherein an under layer comprising synthetic silica and a hydrophilic binder is formed between said base material and said ink absorbing layer.

17. The inkjet recording medium described in claim 12 wherein an under layer comprising synthetic silica and a hydrophilic binder is formed between said base material and said ink absorbing layer.

18. The inkjet recording medium described in claim 3 wherein said polymer dispersion contains, as the monomer component, from 2% by weight to 30% by weight of said cationic monomer.

19. The inkjet recording medium described in claim 4 wherein said polymer dispersion contains, as the monomer component, from 2% by weight to 30% by weight of said cationic monomer.

20. The inkjet recording medium described in claim 5 wherein said polymer dispersion contains, as the monomer component, from 2% by weight to 30% by weight of said cationic monomer.
